(19) United States
(12) Patent Application Publication
(10) Pub. No.: US 2021/0051113 A1
(43) Pub. Date: Feb. 18, 2021

(54) RESOURCE DISTRIBUTION IN A NETWORK ENVIRONMENT

(71) Applicant: International Business Machines Corporation, Armonk, NY (US)

(72) Inventor: Joseph Liu, Nashua, NH (US)

(21) Appl. No.: 16/542,916

(22) Filed: Aug. 16, 2019

(51) Int. Cl. H04L 12/917; H04L 12/911

(52) U.S. Cl. CPC H04L 47/76; H04L 47/82

(57) ABSTRACT

A computer control-plane network controller proactively distributes network resources to network agents (nodes), on-demand, in a dynamic networking environment, based on threshold crossing events reported to the network controller by the nodes. A network agent has a local pool of resources, such as floating IP addresses and TCP/UDP ports, allocated to the network agent by the network controller. As workload assigned to an agent varies, the agent may use correspondingly varying amounts of resources in the local pool to process the workload. An agent reports resource utilization in processing workloads by sending messages to the network controller based on actual resource usage triggered by predefined threshold crossing events. The controller responds to the messages by reclaiming resources from agents reporting a surplus of resources, and re-allocating the resources to agents reporting a deficiency of resources.

### BACKGROUND

The present invention relates generally to the field of computer network management, and more particularly to controlling the distribution of network resources in a networking environment, such as a software defined network.

In a Software Defined Network (SDN), a control plane determines routing for data packets transiting from source nodes to destination nodes. A data plane forwards the data packets in accordance with routings determined by the control plane. A centralized network controller manages and controls the SDN. An SDN (sometimes herein referred to as a data path network) may comprise a large number of nodes (sometimes herein referred to as “network up”.

Network resources are limited. In an SDN environment, the network controller provisions shared network resources among agents used in respective data paths. Examples of network resources include: (i) a pool of public internet protocol (IP) addresses, distributed as needed among network agents, as IP addresses; or (ii) a pool of transmission control protocol/user datagram protocol (TCP/UDP) ports distributed among network agents for Source Network Address Translation (SNAT) performed by the agents.

### SUMMARY

According to an aspect of the present invention, there is a method, computer program product and/or system that performs the following operations (not necessarily in the following order): (i) allocating, in a computer networking environment comprising a plurality of nodes including a first node and a second node, a network resource to the first node and to the second node; (ii) receiving a first threshold crossing event signal from the first node indicating the first node has a surplus amount of the network resource; (iii) receiving a second threshold crossing event signal from the second node indicating the second node has a deficiency of the network resource; and (iv) in response to receiving both the first threshold crossing event signal and the second threshold crossing event signal, re-allocating a portion of the network resource from the first node to the second node.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a mapping diagram showing resource state threshold crossing events in accordance with at least one embodiment of the present invention;

FIG. 5 is a flowchart showing a second embodiment method performed, at least in part, by a second embodiment of a system according to the present invention;

FIG. 6 is a flowchart showing a third embodiment method performed, at least in part, by a third embodiment of a system according to the present invention;

FIG. 7 is a flowchart showing a fourth embodiment method performed, at least in part, by a fourth embodiment of a system according to the present invention; and

FIG. 8 is a flowchart showing a fifth embodiment method performed, at least in part, by a fifth embodiment of a system according to the present invention.

### DETAILED DESCRIPTION

In some embodiments of the present invention, a network controller, and/or a control-plane network controller, proactively distributes network resources to network agents, on-demand, in a dynamic networking environment, based on threshold crossing events reported to the network controller by the network agents. A network agent has a local pool of resources, such as floating IP addresses and TCP/UDP ports, assigned to the agent. In some embodiments, an agent may have multiple pool free counts respectively corresponding to multiple types of resources. Generally, for simplicity of description herein, a single pool free count (of potentially many) associated with a network agent will be discussed. Some embodiments of the present invention distribute TCP/UDP ports among a large number of network nodes (agents) in a distributed network address translation (NAT) environment. Allocation and release of TCP/UDP ports may take place in conjunction with user session setup and/or tear down in accordance with real-time demand. Some embodiments do not maintain a physical (or actual) centralized network resource pool for on-demand distribution to the agents (because resources in the physical central pool are not necessarily used for an actual data path). Instead, the centralized network resource pool may be “virtual”, in the sense all the resources are fully distributed to all agents for data path use, and the central controller uses threshold crossing events from all agents to proactively reclaim and redistribute resources, as if the resources belong to a virtual central pool.

Of the resources in a local pool, those that are allocated to the associated network agent, but are not currently in use, are referred to as a pool free count. To illustrate, if a network agent has ten floating IP addresses allocated to it, but is currently using only one floating IP address, the pool free count of floating IP addresses, for that network agent, is nine.

Network agents have predefined threshold levels (for example, at least a lower threshold and an upper threshold) with respect to the pool free count. Some embodiments assign to network agents a minimum, a low, and a high threshold. If workload assigned to a network agent causes the pool free count to cross a threshold level for a given resource, in a decreasing or an increasing direction, the network agent sends, respectively, a “down cross event” or “up cross event” message to the network controller. The network controller, based on the received threshold-crossing messages, updates its bookkeeping of the network agent pool free count state, and in some embodiments, reclaims a resource from a network agent that has a surplus of the resource (as signaled by an “up cross maximum threshold” event), and redistributes the resource to a network agent that has a deficit (as signaled by a “down cross minimum” event).

In some embodiments of the present invention, a local pool free count of a network resource for a network agent indicates an amount of the network resource (for example, a number of IP addresses) that are allocated to the network agent, but that are not in use by the network agent. The network agent uses however many instances of the network resource that it requires to process a current workload in a specified time interval. For example, consider a network agent that has to receive 1,000 data packets and dispatch them to other network agents in a 10 millisecond time interval. To do so, the network agent may need to use three floating IP addresses, but has ten IP addresses allocated to it. In this scenario, the pool free count of floating IP addresses is seven (10_{allocated}−3_{in use}=7_{free}).

In some embodiments, the threshold levels are selected so as to be predictive of a network resource deficiency (insufficiency), before the workload causes a negative performance impact for the corresponding network agent and the entire data path network as a whole.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

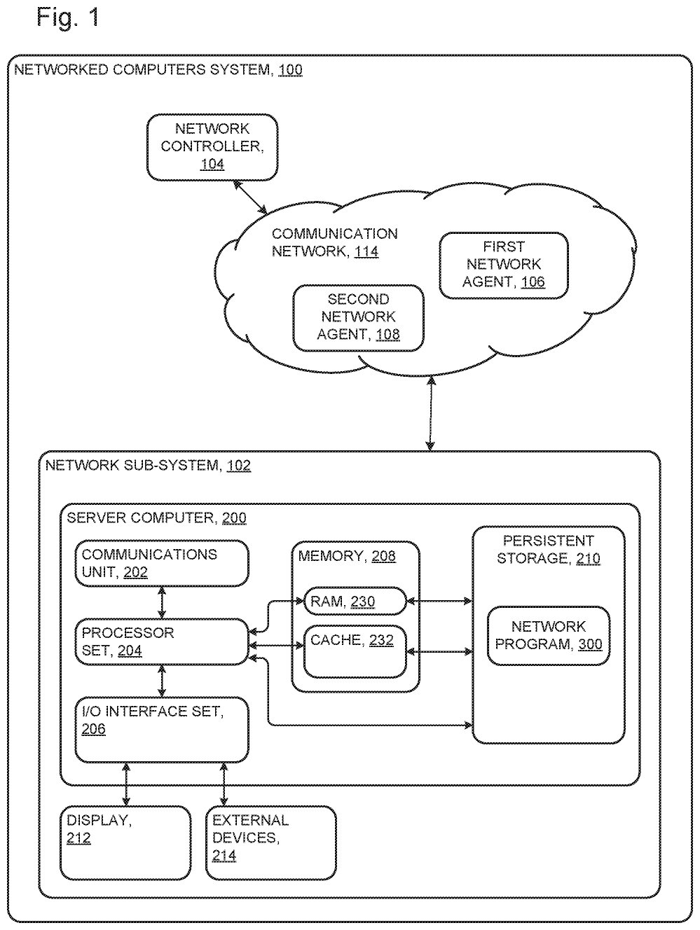

An embodiment of a possible hardware and software environment for software and/or methods according to the present invention will now be described in detail with reference to the Figures. FIG. 1 is a functional block diagram illustrating various portions of networked computers system 100, including: network sub-system 102; network controller 104; first network agent 106; second network agent 108; communication network 114; server computer 200; communications unit 202; processor set 204; input/output (I/O) interface set 206; memory device 208; persistent storage device 210; display device 212; external devices 214; random access memory (RAM) devices 230; cache memory device 232; and network program 300. In some embodiments of the present invention, first network agent 106 and second network agent 108, together, form communication network 114. In some embodiments, communication network 114 includes any number of network agents.

Network sub-system 102 is, in many respects, representative of the various computer sub-system(s) in the present invention. Accordingly, several portions of network sub-system 102 will now be discussed in the following paragraphs.

Network sub-system 102 may be a laptop computer, tablet computer, netbook computer, personal computer (PC), a desktop computer, a personal digital assistant (PDA), a smart phone, or any programmable electronic device capable of communicating with client sub-systems (such as network controller 104, first network agent 106, and second network agent 108) via communication network 114. Network program 300 is a collection of machine readable instructions and/or data that is used to create, manage, and control certain software functions that will be discussed in detail, below, in the Example Embodiment sub-section of this Detailed Description section.

Network sub-system 102 is capable of communicating with other computer sub-systems via communication network 114. Communication network 114 can be, for example, a local area network (LAN), a wide area network (WAN) such as the Internet, or a combination of the two, and can include wired, wireless, or fiber optic connections. In general, communication network 114 can be any combination of connections and protocols that will support communications between server and client sub-systems.

Network sub-system 102 is shown as a block diagram with many double arrows. These double arrows (no separate reference numerals) represent a communications fabric, which provides communications between various components of network sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory device 208 and persistent storage device 210 are computer-readable storage media. In general, memory device 208 can include any suitable volatile or non-volatile computer-readable storage media. It is further noted that, now and/or in the near future: (i) external device(s) 214 may be able to supply, some or all, memory for network sub-system 102; and/or (ii) devices external to network sub-system 102 may be able to provide memory for network sub-system 102.

Network program 300 is stored in persistent storage device 210 for access and/or execution by one or more of the respective computer processor set 204, usually through one or more memories of memory device 208. Persistent storage device 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage device 210.

Network program 300 may include both machine readable and performable instructions and/or substantive data (that is, the type of data stored in a database). In this particular embodiment, persistent storage device 210 includes a magnetic hard disk drive. To name some possible variations, persistent storage device 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage device 210 may also be removable. For example, a removable hard drive may be used for persistent storage device 210. Other examples include optical and magnetic disks, thumb drives, and smart cards that are inserted into a drive for transfer onto another computer-readable storage medium that is also part of persistent storage device 210.

Communications unit 202, in these examples, provides for communications with other data processing systems or devices external to network sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external devices 214. External devices 214 will typically include devices such as a keyboard, keypad, a touch screen, and/or some other suitable input device. External devices 214 can also include portable computer-readable storage media such as, for example, thumb drives, portable optical or magnetic disks, and memory cards. Software and data used to practice embodiments of the present invention, for example, network program 300, can be stored on such portable computer-readable storage media. In these embodiments, the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature, herein, is used merely for convenience, and, thus, the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

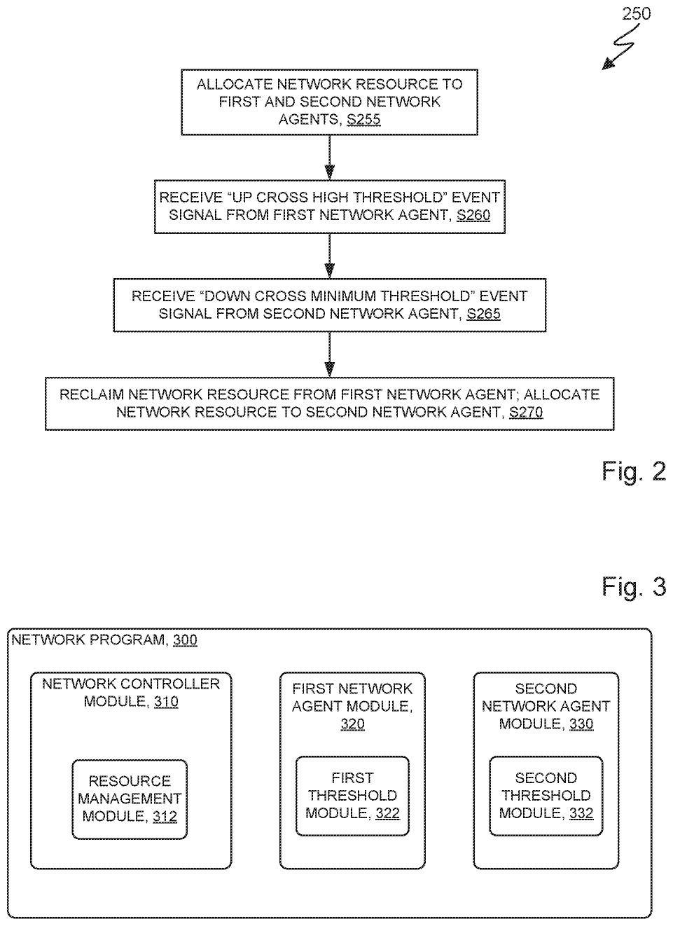

FIG. 2 shows flowchart 250 depicting a method according to the present invention. FIG. 3 shows network program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where resource management module 312, of network controller module, 310, of network program 300, allocates a network resource to first network agent 106 and to second network agent 108, both of communication network 114, of networked computers system 100 (see FIG. 1). In some embodiments, a software defined network (such as, for example, communication network 114) comprises thousands of network agents, including first network agent 106 and second network agent 108 (see FIG. 1).

In the present context, a pool of floating IP addresses constitutes the network resource under discussion. The network controller allocates subsets of the pool of floating IP addresses to various respective network agents. For a given network agent, the subset of floating IP addresses allocated to it comprises a local pool of floating IP addresses. It is to be understood, that in some embodiments, there are multiple types of network resources besides floating IP addresses. Each type is considered and handled independently of the others, yet all types are handled in a similar manner as described in the present discussion.

At some time, first threshold module 322, of first network agent module 320, of network program 300, detects an “up cross high threshold” event with respect to first network agent 106 of networked computers system 100 (see FIG. 1). Threshold crossing events are discussed below in the “Further Comments and/or Embodiments” sub-section of this “Detailed Description” section, in particular with respect to Table 1: Network Agent Response to Threshold crossing events, and the associated discussion.

The “up cross high threshold” event means that the local pool free count of floating IP addresses allocated to first network agent 106 has increased from below a high threshold to above it. First network agent 106 is now considered to have a surplus of floating IP addresses.

In response to detecting the threshold crossing event, first threshold module 322 of first network agent module 320, sends an “up cross high threshold” signal, with respect to floating IP addresses allocated to first network agent 106, to resource management module 312, of network controller module 310, associated with network controller 104 (FIG. 1).

Processing proceeds at operation S260, where resource management module 312, receives the “up cross high threshold” signal.

At some time, second threshold module 332, of second network agent module 330, of network program 300, detects a “down cross minimum threshold” event with respect to second network agent 108 of networked computers system 100 (see FIG. 1).

The “down cross minimum threshold” event means that the local pool free count of floating IP addresses allocated to second network agent 108 has decreased from above a minimum threshold to below the minimum threshold. Second network agent 108 is now running low on floating IP addresses and is considered to have a deficit of floating IP addresses. Second network agent 108 risks not having enough floating IP addresses to handle assigned workload, which could negatively impact second network agent 108 performance (and consequently, overall network performance). In response to detecting the threshold crossing event, second threshold module 332 sends a “down cross minimum threshold” signal, with respect to floating IP addresses allocated to second network agent 108, to resource management module 312, of network controller module 310, associated with network controller 104 (FIG. 1).

Processing proceeds at operation S265 where resource management module 312, receives the “down cross minimum threshold” signal.

Processing proceeds at operation 5270, where, in response to receiving both the “up cross high threshold” and the “down cross minimum threshold” signals, resource management module 312, of network controller module 310, performs the following actions: (i) reclaims at least some of the floating IP addresses from first network agent 106; and (ii) re-allocates some or all of the reclaimed floating IP addresses to second network agent 108.

### III. Further Comments and/or Embodiments

Some embodiments of the present invention may recognize one, or more, of the following facts, potential problems, and/or potential areas for improvement with respect to the current state of the art with regard to software defined networks (SDNs). Demands for network resources are not uniform across all nodes (sometimes herein referred to as network agents) of an SDN and vary over time due to the dynamics of network traffic. A conventional approach for provisioning and managing shared network resources is by means of on-demand requests made by the network agents in need of such resources. Some of the network resources are used to configure data paths at the network agents. If a network agent makes an on-demand request when provisioned resources are exhausted, there may occur a delay or interrupt in data traffic until the needed resources are made available. In a conventional approach for avoiding resource exhaustion, have network agents maintain provisioned local resource pools and respectively corresponding “low thresholds” for the pools. If a network agent detects its free resource pool is approaching or falling below the low threshold, the network agent proactively makes an on-demand request to have the network controller provision more resources to the free pool. However, run-time allocation from a central pool may be insufficiently responsive, may cause delays, increased latency and negative impact to network performance.

In addition, due to the limited network resources and dynamic nature of network traffic, the network controller needs to reclaim under-utilized network resources from some network agents in order to fulfill on-demand requests from other network agents. To find network resources available for reclaiming in some conventional systems, a network controller queries all network agents to discover network agents that have surpluses and/or shortages of such resources. However, in a large network, such queries may be ineffective, whether performed periodically or on-demand.

Some embodiments of the present invention comprise a proactive network resource management scheme to manage centralized network resources for distribution to, and use by, a large number of network agents in handling real-time data path processing.

Some embodiments of the present invention implement a threshold-based resource pool usage measurement at each network agent. Each network agent automatically reports (to the network controller) threshold crossing events based on actual resource pool usage. The network controller automatically, and/or proactively, redistributes network resources among the network agents according to their respective usage levels. The network controller determines resource usage levels at the network agents, based on reports of threshold crossing events, sent by the network agents to the network controller. The network controller, based on threshold crossing event messages, acts proactively to reallocate resources to where they may be most in need, before network agent performance is impacted due to a lack of sufficient resources.

For example, in some embodiments, a network controller reclaims resources from nodes that report a pool free count above a high threshold, and distributes resources to nodes that report a pool free count below a minimum threshold. This approach may be considered a coarse-grained approach.

Some embodiments of the present invention may include one, or more, of the following features, characteristics, and/or advantages: (i) the network controller has information with respect to resource usage levels of all network agents in the SDN (based on individual network agent actual usage events); (ii) the network controller avoids having to periodically poll each network agent to determine usage levels; (iii) the network controller avoids having to account for network agent resource level usage changes; (iv) the network controller proactively reclaims and redistributes network resources based on a three threshold levels of network usage; (v) the network controller offers proactive resource management; (vi) the network controller isolates resource management control plane operation from network agent data plane usage; and/or (vii) the network controller maximizes data plane resource availability at the network agents.

In a software defined network (SDN), controller-agent environment, the network controller maintains a shared global pool of network resources. The controller provisions (distributes) resources among the network agents. Each network agent maintains its own local pool of provisioned network resources. Each network agent configures is data path to allocate or release resources in accordance with traffic demand.

Examples of network resources include transmission control protocol/user datagram protocol (TCP/UDP) ports for distributed source network address translation (SNAT) performed at each network agent, where each network agent uses a given public internet protocol (floating IP) address. In such a case, the network controller allocates a non-overlapping batch of TCP/UDP ports from the network controller global pool, and provisions the ports to each network agent as needed. Each network agent maintains a local pool of such provisioned ports, and performs local allocation and release of the ports in response to local network endpoints opening and closing sockets to access public internet via a shared floating IP address. Due to the non-uniform dynamics of such activities, the network controller proactively reclaims unused ports from under-utilized network agents and provisions the reclaimed ports to over-utilized network agents.

Consider a network agent that has a minimum pool free count threshold set at 25 percent, for floating IP addresses, where the agent has five floating IP addresses assigned to it, three in use. In this case, the network agent has two of the five floating IP addresses that are not currently in use (a pool free count of 2/5, or 40%). If a third floating IP address is put into service, the pool free count drops to 1/5, or 20%, crossing the minimum threshold (25%) in a decreasing direction (from 40% to 20%). This threshold crossing triggers the network agent to send a “down cross minimum threshold” message to the network controller. The network controller responds by assigning at least one additional floating IP address to the network agent, allowing the agent to work at maximum performance. The network controller may reclaim the additional floating IP address from a network agent that has reported an “up cross maximum threshold” message with respect to its floating IP address pool free count.

A method for a network controller to proactively distribute a shared resource to a network agent, in accordance with some embodiments of the present invention, is described in the following enumerated paragraphs:

1) With respect to an associated local network resource pool, each network agent maintains three (configurable) resource pool utilization threshold levels (sometimes herein referred to as “thresholds”): a “high” threshold, a “low” threshold, and a “minimum” threshold. In some embodiments, a resource utilization metric refers to a proportion of available resources (for example, TCP/UDP ports) that are in use over a given time interval. For example, if the network agent has, in its local pool, three TCP/UDP ports and over a one minute interval, the three ports are in use for a combined total of one minute, the resource utilization is 33 percent (3 ports×1 minute=3 port-minutes available; then 1 port-minute usage÷3 port-minutes available=1/3=33% utilization). Other types of resources, and other resource utilization metrics and utilization calculation methods (now known or that may be developed in the future) may be used while remaining within the spirit and scope of the present invention.

2) The network controller defines a report remote procedure call application programming interface (RPC API) by which each network agent reports respective local network resource pool threshold crossing events. A resource threshold level crossing event triggers the associated network agent to call the API.

3) Each network agent defines a pair of provision and reclaim RPC APIs that can be called by the network controller to proactively distribute (redistribute) network resources among all network agents, as demanded by the workloads placed on respective network agents. In some embodiments of the present invention, if a network agent crosses a resource utilization threshold, the network agent notifies the network controller of the threshold crossing. In response, the network controller calls a provision and reclaim RPC API, to proactively (re)distribute a network resource based on the threshold crossing notification.

In some embodiments of the present invention, an algorithm performed at each network agent sets an initial resource provision (for each resource allocated to the network agent) above the network agent's low threshold. The initial amount provisioned may, or may not, be set above the network agent's high threshold. If resource usage (for a given resource) causes a network agent's pool free count to cross a threshold, the network agent responds by calling the report API to report the threshold crossing event to the network controller, as tabulated in Table 1: Network Agent Response to Threshold Crossing Events table below.

TABLE 1
Network Agent Response to Threshold Crossing Events

| Event: Resource usage | Response: Network |
|---|---|
| causes a network agent's | agent calls report |
| pool free count to cross from: | API to report: |
| above the high_threshold | down cross |
| to below it | high_threshold |
| above the low_threshold | down cross |
| to below it | low_threshold |
| above the minimum_threshold | down cross |
| to below it | minimum_threshold |
| below the minimum_threshold | up cross |
| to above it | minimum_threshold |
| below low_threshold | up cross |
| to above it | low_threshold |
| below high-threshold | up cross |
| to above it | high_threshold |

In some embodiments of the present invention, a network controller performs the following actions: (i) keeps track of network usage state based on threshold crossing events reported by the network agents (via the report API) as discussed above; (ii) keeps track of network resource usage by each network agent with respect to (at least) the three thresholds (minimum, low, and high); and/or (iii) proactively distributes (or redistributes) network resources to ensure a resource is available to the network agent data path, when the resource is needed (in response to a workload shift for the network agent). The network controller, by responding to threshold crossings, is able to redistribute resources before a pool free count falls to zero, which would negatively impact network performance.

In some embodiments of the present invention, if the network controller receives a down cross the minimum_threshold report from a given network agent (for a given resource), the network controller reclaims the given network resource from other network agent(s) that have more pool free count of the given resource. These other network agent(s) are selected based on having last reported calls of up cross high_threshold. The network controller then distributes the given resource to the given network agent.

In some embodiments of the present invention, generally, the network controller redistributes network resources from network agents which most recently sent report calls of up cross high_threshold, to network agents which most recently sent report calls of down cross minimum_threshold. In this way, resources are shifted from network agents that have a surplus of the resource to network agents that have a shortage of the resource. The shifting of resources, by virtue of the pre-determined thresholds, avoids a critical shortage of the resource, at a given network agent, that would negatively impact network performance.

In some embodiments of the present invention, a proactive network resource management scheme manages centralized network resources for distribution to, and use by, a large number of network agents in handling real-time data path processing. An example of such a resource is a pool of transmission control protocol/user datagram protocol (TCP/UDP) ports for distribution among a large number of network agents to implement distributed source network address translation (SNAT) in the network agents.

Some embodiments of the present invention use a threshold-based resource pool usage measurement at each of the large number of network agents. A network agent reports, to the network controller, threshold crossing events based on actual resource pool usage. A threshold crossing event may occur when a resource usage (for a network agent) increases to a level that is greater than an upper threshold, or declines to a level that is less than a lower threshold. In response, the network controller proactively redistributes network agents according to respective usage levels, based on the received threshold crossing event reports.

A scheme for proactive network controller-agent resource distribution, in accordance with some embodiments, is described in the few following paragraphs.

Each network agent establishes and maintains three resource pool utilization thresholds corresponding to the agent's local network resource pool: (i) a high threshold; (ii) a low threshold; and (iii) a minimum threshold. The number of thresholds (three in the present discussion) is configurable, meaning that network agents, in some embodiments, use three thresholds, some network agents may use more, and some may use fewer. Some embodiments implement a finer-grained approach, where three thresholds are assigned to the nodes: “high”, “low”, and “minimum”.

A network controller for each network agent defines a report remote procedure call (RPC) application programming interface (API). A network agent calls the API to report local network resource pool threshold crossing events. In some embodiments, the API call is triggered by the actual resource level threshold crossing (as opposed to periodic reporting calls, or by responses to queries made by the network controller).

Each network agent defines a pair of provision and reclaim RPC APIs. By using these APIs, the network controller proactively distributes and/or redistributes, in accordance with real-time demand, network resources among network agents in the purview of the network controller.

In some embodiments of the present invention, the network controller performs the following operations (algorithm): (i) maintains a current network usage state; (i) updates the network usage state in response to, and in accordance with, threshold events reported by network agents; (iii) proactively performs network resource distribution and/or redistribution, based on the network usage state, to ensure one or more data paths associated with each network agent is provisioned with an adequate amount of resources, neither too much (which wastes resources that could be used elsewhere) nor too little (which negatively impacts network agent performance).

Based on the current network usage state as well as incoming reports of threshold events, the network controller has information on the current status of each network agent with respect to its resource usage in relation to the three corresponding thresholds. Based on this information, the network controller proactively redistributes network resources to ensure the network agents respective data paths are provisioned with sufficient resources to handle assigned workload within established parameters for latency, throughput, and/or other performance measures.

In some embodiments, a network controller keeps track of four states with respect to each network agent, as follows: (i) state-1—above the “high” threshold (the node reported an “up cross high threshold” event); (ii) state-2—between “high” and “low” thresholds (the node reported either a “down cross high threshold” or an “up cross low threshold”) event; (iii) state-3—between “low” and “minimum” thresholds (the node reported either a “down cross low threshold” or an “up cross minimum threshold” event); and (iv) state-4—below “minimum” threshold (the node reported a “down cross minimum threshold” event).

Some embodiments operate on an “optimistic” redistribution algorithm according to which the network controller reclaims resources from nodes in state-1, and redistributes the resources to nodes in state-4.

Some embodiments operate on a “pessimistic” redistribution algorithm according to which the network controller reclaims resources from nodes in state-1 (preferentially) and then state-2 (secondarily), and redistributes the resources to nodes in state-4 (preferentially) and then state-3 (secondarily).

Some embodiments of the present invention may include one, or more, of the following features, characteristics, and/or advantages: (i) dynamically partitions and shares a network resource among a large number of network agents (nodes) in a software defined network (SDN) environment; (ii) dynamically partitions and shares a network resource among a large number of nodes in a data path network environment; (iii) proactively monitors and re-distributes control-plane network resources to prevent resource unavailability and consequent interruption of data-plane network component operation; (iv) individual nodes report respective resource usage levels based on threshold crossing events corresponding to real resource state change; (v) meets the dynamic resource demand of real-time data-plane operations; (vi) proactively monitors and re-distributes control-plane network resources to subsystems based on real-time dynamic usage; (vii) prevents potential resource unavailability; and/or (viii) threshold crossing reporting scheme based on resource usage avoids unnecessary polling of subsystems for usage information.

In some embodiments of the present invention, examples of network resources include: (i) floating IP addresses; (ii) TCP/UDP ports; (iii) virtual extensible local area network (VxLAN) identifiers; and (iv) application processing identifiers, to name a few. In general, a network resource is any limited, globally unique (thus centrally managed) resource, that is distributed to a number of execution entities (central processing units (CPUs), data-plane nodes, compute nodes, storage nodes, etc.) where the entities use the resource “on-demand” and/or in “real-time” (for example, networking data-plane activities).

Further with respect to item (iii) in the paragraph above, in some embodiments, any number of compute nodes use VxLAN identifiers to establish a virtual network VxLAN overlay. Further with respect to item (iv) in the paragraph above, in a distributed computer cluster, where each application may be run on any number of computer nodes, each application receives a globally unique application process identifier (a network resource) to be used in communication between and among applications running among the computer nodes of the cluster. Some embodiments of the present invention pre-distribute such application process identifiers to the computer nodes, and monitor and re-distribute them among the computer nodes in such a manner that any real-time allocation and release of application process identifiers, at a given node, is a local operation.

Some embodiments of the present invention may be practiced in networks other than software defined networks. Some examples include telephone switching networks, cell phone networks, local and wide area networks (respectively LANs and WANs), to name only a few.

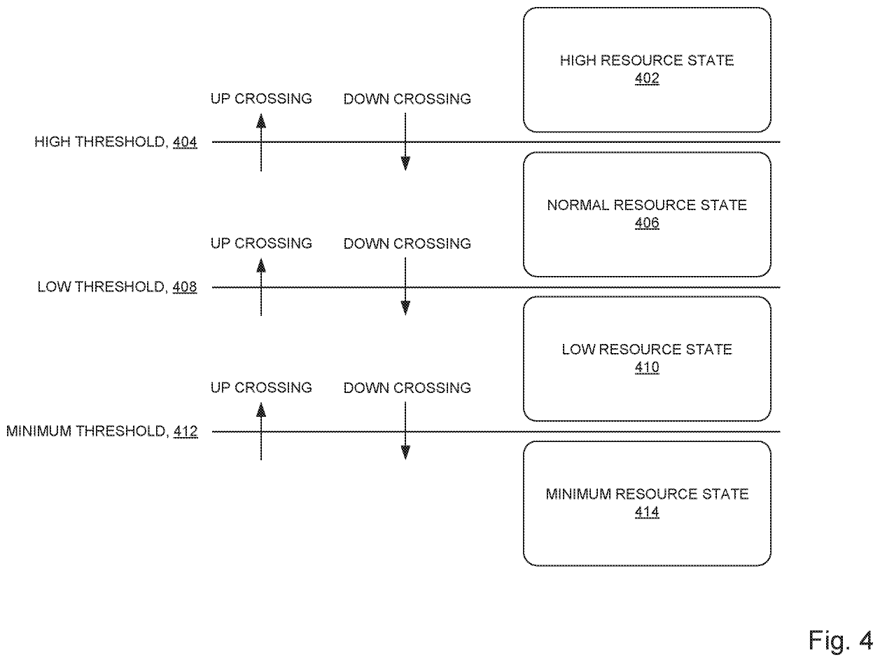

FIG. 4 is a diagram that maps network agent threshold crossing events to resource states, in accordance with some embodiments of the present invention. A network controller maintains (performs bookkeeping with respect to) a network agent's resource state, based on threshold crossing event messages received from the network agent. In some embodiments, network agent resource states include high resource state 402, normal resource state 406, low resource state 410, and/or minimum resource state 414. The boundary between high resource state 402 and normal resource state 406 is high threshold 404. The boundary between normal resource state 406 and low resource state 410 is low threshold 408. The boundary between low resource state 410 and minimum resource state 414 is minimum threshold 412.

As indicated by up crossing and down crossing event arrows, a network agent transitions from one resource state to another, depending on resources allocated versus resources needed to process assigned workload. For example, if a network agent workload increases causing it to transition from normal resource state 406 to low resource state 410, the transition comprises a down crossing event with respect to low threshold 408. The threshold crossing event triggers the network agent to send a “down crossing low threshold” message to the network controller. Similarly, if a network agent workload decreases causing it to transition from normal resource state 406 to high resource state 402, the transition comprises an up crossing event with respect to high threshold 404. The threshold crossing event triggers the network agent to send an “up crossing high threshold” message to the network controller.

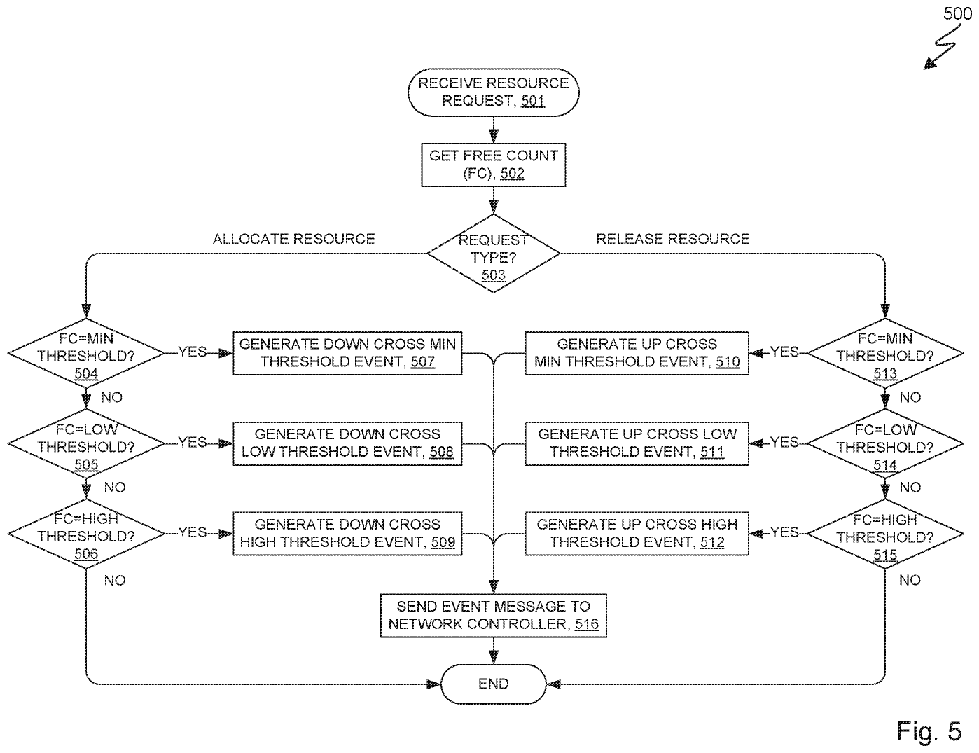

Flowchart 500 of FIG. 5 illustrates a process by which a network agent generates (or does not generate) a threshold crossing event message, and sends the message, if generated, to a network controller, in accordance with some embodiments of the present invention. The network agent generates a proper threshold crossing event, based on resource allocation or release. The network agent raise threshold crossing event process includes operations 501, 502, 503, 504, 505, 506, 507, 508, 509, 510, 511, 512, 513, 514, 515, and 516, with process flow among and between the operations as shown by arrows.

A network agent receives a resource request (501). For this discussion, consider that the request involves an IP address. The network agent obtains (or otherwise determines) (502) its pool free count with respect to IP addresses. Processing the resource request causes the network agent to pick up an IP address from the pool (503, “Allocate Resource” branch). The pool free count drops, as there are now fewer unused instances of the network resource. Consequently, if the pool free count (for IP addresses) drops below the minimum threshold (504, “Yes” branch), the network agent generates a down cross minimum threshold event message (507). If the pool free count drops below the low threshold (505, “Yes” branch), the network agent generates a down cross low threshold event message (508). If the pool free count drops below the high threshold (506, “Yes” branch), the network agent generates a down cross high threshold event message (509). The network agent sends (516) the message (generated at operations 507, 508, or 509) to the network controller.

Alternatively, consider that processing the resource request causes the network agent to release an IP address (503, “Release Resource” branch) back to the pool. The pool free count rises, as there are now more unused instances of the network resource. Consequently, if the pool free count (for the network resource) rises above the minimum threshold (513, “Yes” branch), the network agent generates an up cross minimum threshold event message (510). If the pool free count rises above the low threshold (514, “Yes” branch), the network agent generates an up cross low threshold event message (511). If the pool free count rises above the high threshold (515, “Yes” branch), the network agent generates an up cross high threshold event message (512). The network agent sends the generated message (generated at operations 510, 511, or 512) to the network controller (516).

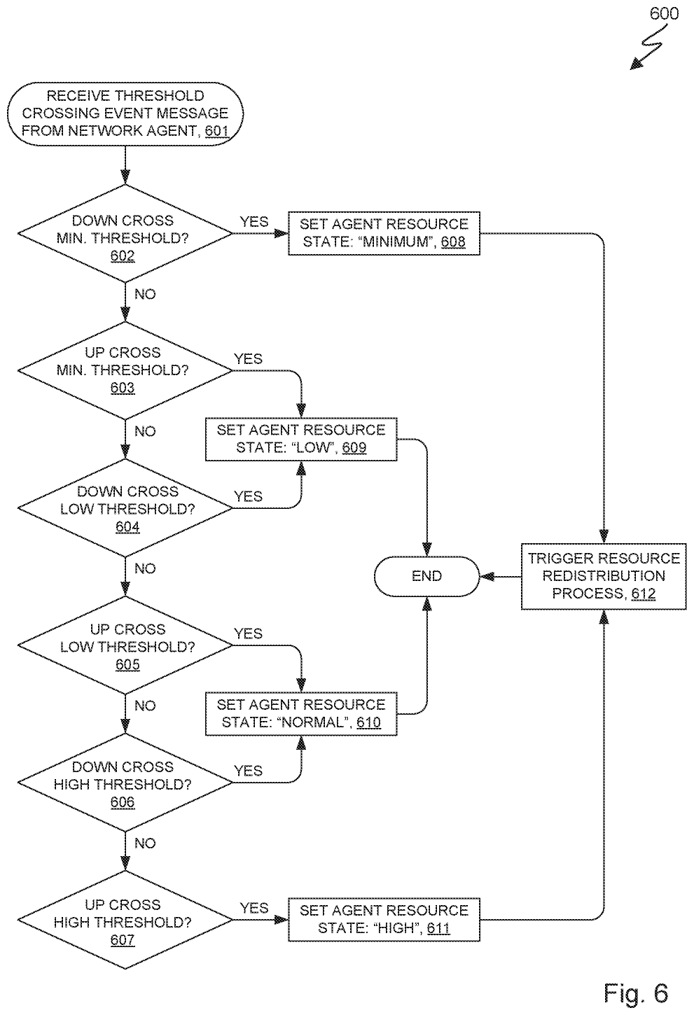

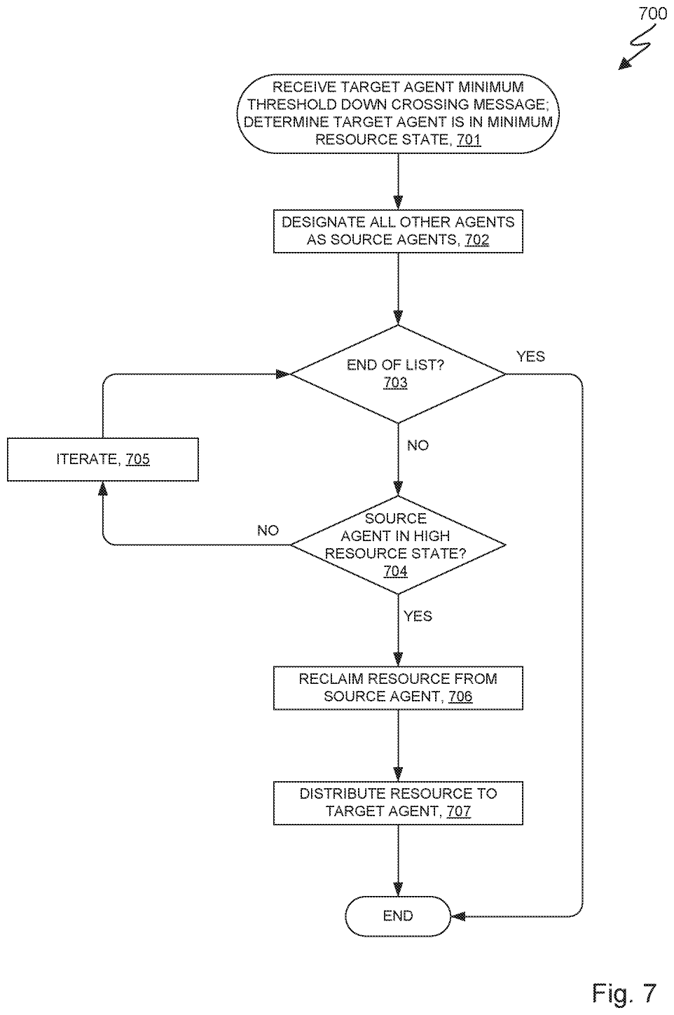

Flowchart 600 of FIG. 6 illustrates a process whereby a network controller derives a network agent resource state, in accordance with some embodiments of the present invention. The network controller derives a current resource state of a network agent, based on threshold crossing event messages received from the network agent. The network controller triggers a resource redistribution process based on a network agent state transition. The process includes operations 601, 602, 603, 604, 605, 606, 607, 608, 609, 610, 611, 612 and 613, with process flow among and between the operations as shown by arrows.

In some embodiments of the present invention, the network controller maintains a state table which contains record-keeping information on the state of each network agent with respect to network resources allocated thereto. In response to receiving up cross and down cross messages from network agents, the network controller updates the state table such that the state table has real-time state information, with respect to network agents under control of the network controller, and the network resources respectively allocated thereto. The state table may take on many different forms, and is not limited to a “table” data concept. The state table may be: (i) a relational database; (ii) a spreadsheet-type data structure; (iii) a self-referential database; (iv) a flat-file data structure; and/or (v) any data structure now known or developed in the future, that is suitable to perform the record-keeping task described above in this paragraph.

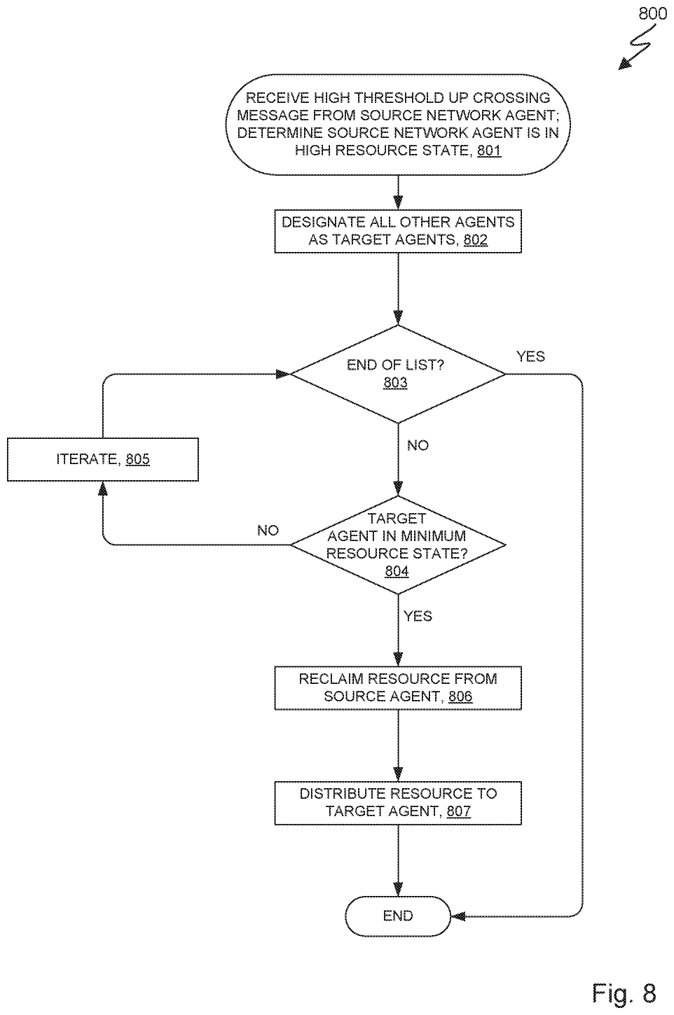

In some embodiments, the state table is maintained as two logically sorted data structures as follows: (i) a list of network agents sorted by resource state in descending order, where network agents with higher resource states come before those with lower resource state; and/or (ii) a list of network agents sorted by resource state in ascending order, where network agents with lower resource states come before those with higher resource states. Usage of the sorted network agent resource state lists may be helpful for decision making searches described below with respect to FIGS. 7 and 8.

With reference to flowchart 600, a network controller receives a threshold crossing event message from a network agent (601). If the message is a down cross minimum threshold message (602, “Yes” branch), the network controller updates the state table to indicate that the network agent is at state “minimum” (608), and triggers a resource redistribution process (612), to allocate more of the resource to the network agent. If the message is an up cross minimum threshold message (603, “Yes” branch), the network controller updates the state table to indicate that the network agent is in a “low” state (609). If the message is a down cross low threshold message (604, “Yes” branch), the network controller updates the state table to indicate that the network agent is in a “low” state (609). If the message is an up cross low threshold message (605, “Yes” branch), the network controller updates the state table to indicate that the network agent is in a “normal” state (610). If the message is a down cross high threshold message (606, “Yes” branch), the network controller updates the state table to indicate that the network agent is in a “normal” state (610). If the message is an up cross high threshold message (607, “Yes” branch), the network controller updates the state table to indicate that the network agent is in a “high” state (611), and triggers a resource redistribution process (613), to reallocate some instances of the resource to a network agent in “minimum” state (with respect to the network resource).

Flowchart 700 of FIG. 7 illustrates a network controller proactive resource redistribution process (triggered by agent resource minimum), in accordance with some embodiments of the present invention. In response to receiving, from a network agent, a message indicating that the network agent has transitioned to a minimum resource state (see minimum resource state 414 of FIG. 4), the network controller proactively redistributes more of the network resource to the network agent. The network controller proactively reclaims at least some of the resource from a network agent in a high resource state (see high resource state 402 of FIG. 4), and reallocates at least some of the reclaimed resource to the network agent in a minimum resource state. A down cross minimum threshold event message (see minimum threshold 412 of FIG. 4) received by the network controller, from the network agent, indicates that the network agent transitioned to a minimum resource state, which in turn triggers the network controller to perform the reallocation process. The network controller proactive resource redistribution process (triggered by agent resource minimum) includes operations 701, 702, 703, 704, 705, 706, and 707, with process flow among and between the operations as shown by arrows.

With reference to flowchart 700, a network controller receives, from a network agent, a minimum threshold down crossing message. Based on the message, the network controller determines (701) that the network agent (now designated as a target agent for discussion), is in a minimum resource state. The network controller designates (702) all network agents, other than the target agent, as source (or potential source) agents. The network controller begins stepping through the state table to identify a network agent that is in a high resource state. While stepping through the state table (operations 703, “No” branch; 704 “No” branch; and 705), the network controller identifies a network agent (now designated as a source agent for discussion) that is in a high resource state (704, “Yes” branch). The network controller reclaims at least one instance of the resource from the source agent (706), and distributes the resource to the target agent (707).

Some embodiments search for a source network agent by selecting the first network agent on the sorted network agent resource state list, sorted in descending order (described above with respect to FIG. 6). If the first network agent is in a high resource state, the network agent is marked as being available as a source agent for resource redistribution. Since the first network agent on the list represents the highest resource state of all network agents listed, if this network agent is in a state lower than the high resource state, there are guaranteed to be no network agents at a high resource state, thus no network agents are available as a source to supply surplus network resources.

Flowchart 800 of FIG. 8 illustrates a network controller proactive resource redistribution process (triggered by agent resource high) performed by a network controller, in accordance with some embodiments of the present invention. In response to receiving, from a network agent, a message indicating that the network agent has transitioned to a high resource state (see high resource state 402 of FIG. 4), the network controller proactively reclaims at least some of the resource and redistributes at least some of the reclaimed resource to a network agent in a minimum resource state (see minimum resource state 414 of FIG. 4). The network controller proactive resource redistribution process (triggered by agent resource high) includes operations 801, 802, 803, 804, 805, 806, and 807, with process flow among and between the operations as shown by arrows.

With reference to flowchart 800, a network controller receives, from a network agent, a high threshold up crossing message. Based on the message, the network controller determines (801) that the network agent (now designated as a source agent for discussion), is in a high resource state. The network controller designates (802) all network agents, other than the source agent, as target (or potential target) agents. The network controller begins stepping through the state table to identify a network agent that is in a minimum resource state. While stepping through the state table (operations 803, “No” branch; 804, “No” branch; and 805), the network controller identifies a network agent (now designated as a target agent for discussion) that is in a minimum resource state (804, “Yes” branch). The network controller reclaims at least one instance of the resource from the source agent (806), and distributes the resource to the target agent (807).

Some embodiments search for target network agents by selecting the first network agent on the sorted network agent resource state list, sorted in ascending order (described above with respect to FIG. 6). If the first network agent is in a minimum resource state, the network agent is designated as a target agent and is marked for receiving additional network resources. Since the first network agent on the list represents the lowest state of all network agents listed, if this network agent is in a state higher than the minimum resource state, there are guaranteed to be no network agents at a minimum resource state, thus no target network agents are in need of receiving re-allocated network resources.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, and/or application-specific integrated circuit (ASIC) based devices.

What is claimed is:

1. A computer-implemented method comprising:
allocating, in a computer networking environment comprising a plurality of nodes including a first node and a second node, a network resource to the first node and to the second node;
receiving a first threshold crossing event signal from the first node indicating the first node has a surplus amount of the network resource;
receiving a second threshold crossing event signal from the second node indicating the second node has a deficiency of the network resource; and
in response to receiving both the first threshold crossing event signal and the second threshold crossing event signal, re-allocating a portion of the network resource from the first node to the second node.

2. The method of claim 1, wherein:
the first threshold defines an unused amount of the network resource, above which a respective node is considered to have a surplus amount of the network resource; and
the second threshold defines an unused amount of the network resource, below which the respective node is considered to have an insufficient amount the network resource.

3. The method of claim 1, wherein the networking environment is a software defined network.

4. The method of claim 1, wherein the network resource is selected from the group consisting of: an internet protocol address (IP address); a transmission control protocol port (TCP port); a user datagram protocol port (UDP port); a virtual extensible local area network identifier; and an application processing identifier.

5. The method of claim 1, further comprising:
detecting, by the first node, a threshold crossing event with respect to the network resource based on: (i) the first threshold, and (ii) an amount of the network resource required by the first node to process a workload assigned to the first node in a pre-defined time interval.

6. The method of claim 1, further comprising:
maintaining information with respect to a state of the first network agent and a network resource allocated thereto.

7. The method of claim 6, wherein the state of the first network agent, with respect to the network resource allocated thereto, is selected from the group consisting of a high resource state, a normal resource state, a low resource state, and a minimum resource state.

8. A computer program product comprising a computer readable storage medium having stored thereon program instructions programmed to perform:
allocating, in a computer networking environment comprising a plurality of nodes including a first node and a second node, a network resource to the first node and to the second node;
receiving a first threshold crossing event signal from the first node indicating the first node has a surplus amount of the network resource;
receiving a second threshold crossing event signal from the second node indicating the second node has a deficiency of the network resource; and
in response to receiving both the first threshold crossing event signal and the second threshold crossing event signal, re-allocating a portion of the network resource from the first node to the second node.

9. The computer program product of claim 8, wherein:
the first threshold defines an unused amount of the network resource, above which a respective node is considered to have a surplus amount of the network resource; and
the second threshold defines an unused amount of the network resource, below which the respective node is considered to have an insufficient amount the network resource.

10. The computer program product of claim 8, wherein the networking environment is a software defined network.

11. The computer program product of claim 8, wherein the network resource is selected from the group consisting of: an internet protocol address (IP address); a transmission control protocol port (TCP port); a user datagram protocol port (UDP port); a virtual extensible local area network identifier; and an application processing identifier.

12. The computer program product of claim 8, further comprising program instructions programmed to perform:
detecting, by the first node, a threshold crossing event with respect to the network resource based on: (i) the first threshold, and (ii) an amount of the network resource required by the first node to process a workload assigned to the first node in a pre-defined time interval.

13. The computer program product of claim 8, further comprising program instructions programmed to perform:
maintaining information with respect to a state of the first network agent and a network resource allocated thereto.

14. The computer program product of claim 13, wherein the state of the first network agent, with respect to the network resource allocated thereto, is selected from the group consisting of a high resource state, a normal resource state, a low resource state, and a minimum resource state.

15. A computer system comprising:
a processor set; and
a computer readable storage medium;
wherein:
the processor set is structured, located, connected and/or programmed to run program instructions stored on the computer readable storage medium; and
the program instructions include instructions programmed to perform:
allocating, in a computer networking environment comprising a plurality of nodes including a first node and a second node, a network resource to the first node and to the second node;
receiving a first threshold crossing event signal from the first node indicating the first node has a surplus amount of the network resource;
receiving a second threshold crossing event signal from the second node indicating the second node has a deficiency of the network resource; and
in response to receiving both the first threshold crossing event signal and the second threshold crossing event signal, re-allocating a portion of the network resource from the first node to the second node.

16. The computer system of claim 15, wherein:
the first threshold defines an unused amount of the network resource, above which a respective node is considered to have a surplus amount of the network resource; and
the second threshold defines an unused amount of the network resource, below which the respective node is considered to have an insufficient amount the network resource.

17. The computer system of claim 15, wherein the networking environment is a software defined network.

18. The computer system of claim 15, wherein the network resource is selected from the group consisting of: an internet protocol address (IP address); a transmission control protocol port (TCP port); a user datagram protocol port (UDP port); a virtual extensible local area network identifier; and an application processing identifier.

19. The computer system of claim 15, further comprising program instructions programmed to perform:
detecting, by the first node, a threshold crossing event with respect to the network resource, based on: (i) the first threshold, and (ii) an amount of the network resource required by the first node to process a workload assigned to the first node in a pre-defined time interval.

20. The computer system of claim 15, further comprising program instructions programmed to perform:
maintaining information with respect to a state of the first network agent and a network resource allocated thereto;
wherein the state of the first network agent, with respect to the network resource allocated thereto, is selected from the group consisting of a high resource state, a normal resource state, a low resource state, and a minimum resource state.
